(19) United States
(12) Patent Application Publication
(10) Pub. No.: US 2025/0365781 A1
(43) Pub. Date: Nov. 27, 2025

(54) SYSTEMS AND METHODS FOR INTEGRATING P-CSCF WITH ENUM FOR ENHANCED NETWORK FUCTIONALITY

(71) Applicant: T-Mobile Innovations LLC, Overland Park, KS (US)

(72) Inventor: Chandrashekhar BHANDARI, Issaquah, WA (US)

(21) Appl. No.: 18/671,108

(22) Filed: May 22, 2024

(51) Int. Cl. H04W 76/10; H04L 67/56; H04W 8/26

(52) U.S. Cl. CPC H04W 76/10; H04L 67/56; H04W 8/26

(57) ABSTRACT

Systems and methods are provided for integrating P-CSCF with ENUM for enhanced network functionality. An example method may include receiving, at a proxy server, a request to make a connection from a wireless device to a destination device. The method may further include querying, directly by the proxy server, a database for a URI of the destination device, wherein the database comprises mappings of phone numbers to URIs.

### TECHNICAL BACKGROUND

A wireless network, such as a cellular network, can include an access node (e.g., base station) serving multiple wireless devices in a geographical area covered by a radio frequency transmission provided by the access node. Access nodes may deploy different carriers within the cellular network utilizing different types of radio access technologies (RATs). RATs can include, for example, 4G RATs (new radio (NR)). Further, different types of access nodes may be implemented for deployment for the various RATs. Evolved NodeB (eNodeB or eNB) may be utilized for 4G RATs. Next generation NodeB (gNodeB or gNB) may be utilized for 5G RATs.

Placing a cellular phone call uses many different resources within the cellular providers network, including many different server functions. These server functions work together to coordinate the call process. With so many calls being placed daily, any manner of making the process more efficient would be enormously beneficial.

### OVERVIEW

Examples described herein include systems and methods for integrating Proxy Call Cession Control Function (P-CSCF) with E.164 Number Mapping (ENUM) for enhanced network functionality. An exemplary method includes receiving, at a proxy server, a request to make a connection from a wireless device to a destination device. The method further includes querying, directly by the proxy server, a database for a Uniform Resource Identifier (URI) of the destination device, wherein the database comprises mappings of phone numbers to URIs.

Another exemplary embodiment includes a system with a proxy server, including at least one electronic processor configured for executing instructions to perform operations. The operations include receiving a request to make a connection from a wireless device to a destination device. The operations further include querying a database for a Uniform Resource Identifier (URI) of the destination device, wherein the database comprises mappings of phone numbers to URIs.

Another exemplary method includes receiving, at a P-CSCF, a request to place a call from a wireless device to a destination device. The method further includes querying an ENUM database, directly by the P-CSCF using DNS, SIP Redirection, Lightweight Directory Access Protocol (LDAP), or other protocols for a Uniform Resource Identifier (URI) of the destination device.

### BRIEF DESCRIPTION OF DRAWINGS

These and other more detailed and specific features of various embodiments are more fully disclosed in the following description, reference being had to the accompanying drawings, in which:

FIG. 1 illustrates an example system for wireless communication in accordance with various aspects of the present disclosure;

FIG. 2 illustrates an exemplary operating environment for integrating P-CSCF with ENUM for enhanced network functionality;

FIG. 3 illustrates an example processing node in accordance with various aspects of the present disclosure;

FIG. 4 illustrates an example process flow for integrating P-CSCF and ENUM; and

FIG. 5 illustrates an example process flow for integrating P-CSCF and ENUM.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In accordance with various aspects of the present disclosure, a wireless network may be provided by many components working together. Some of these components include access nodes, Session Border Controllers (SBCs), and the IP Multimedia Subsystem (IMS). The IMS includes many server functions, such as the Proxy Call Session Control Function (P-CSCF), Serving CSCF (S-CSCF), Interrogating CSCF (I-CSCF), Telephony Application Server (TAS), Home Subscriber Service (HSS) and the database mapping phone numbers to Uniform Resource Identifiers (URI). This database is often referred to by the name of the standard defining the database, ENUM (E.164 Number Mapping).

When a wireless device registers with a cellular provider's network, it receives the address of the P-CSCF it is to use following Packet Data Protocol (PDP) context activation. The P-CSCF acts as the first point of contact for the wireless device for seeking services on the network, such as voice calls, video calls or Rich Communication Services (RCS) messaging, for example. The P-CSCF accepts requests from the wireless device and services them internally or forwards them on to the other components of the IMS, as necessary. Some examples of this follow here. The P-CSCF forwards the Session Initiation Protocol (SIP) register request from the wireless device to an I-CSCF determined using the home domain name provided by the wireless device. The P-CSCF forwards SIP messages received from the wireless device to the SIP server (e.g. an S-CSCF) whose name the P-CSCF has received as part of the registration procedure. As part of processing the request and before forwarding, the P-CSCF may modify the request URI of outgoing requests according to a set of provisioned rules defined by the network provider. The P-CSCF forwards SIP request and responses destined for the wireless device. The P-CSCF may detect an emergency session and select an S-CSCF in the visited network to handle emergency sessions. The P-CSCF generates Call Detail Records (CDRs). The P-CSCF maintains a security association between itself and each wireless device.

Typically, once the P-CSCF has forwarded a SIP message for initiating a call to the S-CSCF, the S-CSCF possibly in conjunction with the TAS and/or I-CSCF will perform an ENUM lookup to find the SIP URI for the destination of the call. ENUM is used to query the database that contains a mapping between phone numbers and domain names. ENUM responds to the TAS, S-CSCF and/or I-CSCF with a result containing a URI such as: provider.com, or rcs.provider.com, for example, where provider is the name of the service provider serving the phone number being looked up. At this point, the S-CSCF knows whether the call is destined to stay within the provider's network or whether it needs to be routed to the network of another provider. If the call is staying within the provider's network, it is handled internally. However, if the call is destined for another provider's network, it will eventually be forwarded to a Session Border Controller (SBC) of the originating provider which interfaces with an SBC of the destination provider to route the call on their end.

When the P-CSCF transmits the request to the S-CSCF to initiate a call, several parameters are sent with the request. These may include parameters necessary for establishing the call, the location of the wireless device, the P-Visited-Network-ID (PVNI), parameters indicating the hardware and software being used within the IMS, and some other non-standard SIP parameters. PVNI indicates the location of the wireless device, to the level of the coverage area of the visited network. For a national network, for example, PVNI would reveal the country the wireless device is in.

Some of these parameters may be considered proprietary information and not necessary to complete the call. In the process of routing the call, these parameters are forwarded along to the interim servers and eventually to the destination of the call. If that call is external to the originating provider's network, some of the unnecessary parameters send information to another provider that may be better kept private. These parameters should not be sent across peering interfaces unless there is an explicit trust relationship between the peering parties. This is primarily for privacy reasons, to prevent the disclosure of potentially sensitive information about network internals to other entities. For example, PVNI helps in identifying the network that the wireless device is currently using. This information can be utilized for applying the correct network policies and for charging based on the wireless device's location and the network being accessed. Hence, this information should not be transmitted outside the originating provider's network. Sending these parameters may also be a violation of RFC standards.

There currently is no direct connection between the P-CSCF and the ENUM service. Some efficiencies and service improvements may be had by adding a direct connection between the P-CSCF and the ENUM service. Without a direct connection to ENUM, the process of resolving E.164 numbers to SIP URIs may involve additional hops or queries to other network elements. This can increase latency in call setup times, affecting the overall user experience. The lack of direct ENUM connectivity forces the P-CSCF to depend on other network elements, such as the S-CSCF to perform number resolution. This can increase the complexity of the network architecture and increase potential points of failure.

Instead of relying on other network elements to determine the URI of the destination device, the P-CSCF may perform the query itself. Once it has that information, it can transmit it to the relevant service (e.g. the S-CSCF) along with the request from the wireless device to place the call. With the P-CSCF already querying for the URI, the S-CSCF and other IMS functions no longer need to perform that query. If the P-CSCF queries ENUM directly the network may be more streamlined, and it may allow decisions to be made and calls to be routed more efficiently. This approach decreases the time and complexity typically involved in routing calls or sessions, enabling swifter connection establishment. For example, the P-CSCF can determine from the ENUM lookup that the call is destined to stay within the providers network and make a routing decision at this point rather than forwarding it to another service within the IMS to make the routing decision.

By incorporating the direct connection between the P-CSCF and ENUM, the network design becomes more straightforward, diminishing the need for extra signaling and routing elements. This streamlining effect can contribute to a decrease in both operational and ongoing maintenance time and expense. This integration facilitates the creation of more innovative and adaptable services, making the most of ENUM's extensive routing features.

If the call is destined for outside the provider's network, unnecessary parameters may be omitted from the communication before it is forwarded to the other services in the IMS and eventually to the other provider. This can prevent leaking private information to the other provider including the location of the originating wireless device (both the actual location of the device and the PVNI information) as well as other proprietary information, such as the hardware and software being used by the provider within their network. Sending of these unnecessary parameters might violate RFC standards.

While the preceding explanation discusses placing a phone call from an originating device to a destination device, it should be understood that the process is similar for other types of connections between devices including RCS messaging, video calling and the like.

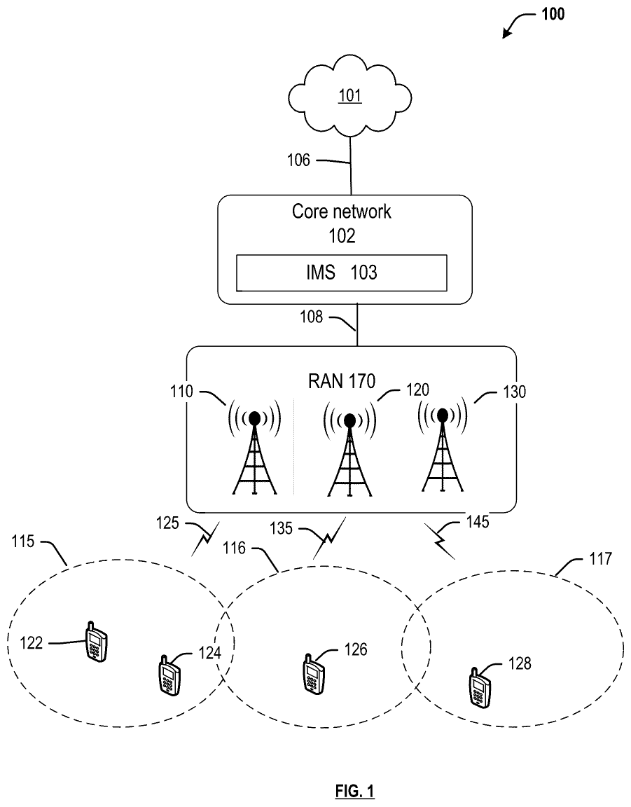

FIG. 1 depicts an exemplary system 100 for wireless communication, in accordance with the disclosed embodiments. System 100 may include a communication network 101, core network 102, and a radio access network (RAN) 170 including access nodes 110, 120, and 130. The RAN 170 may include other devices and additional access nodes. Although three access nodes are shown, any number of access nodes may be included.

System 100 also includes multiple wireless devices 122, 124, 126, and 128, which may be end-user wireless devices and may operate within one or more coverage areas 115, 116, and 117. The wireless devices 122, 124, 126, 128 communicate with access nodes 110, 120, and/or 130 within the RAN 170 over communication links 125, 135, and 145, which may for example be 4G NR communication links.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 122, 124, 126, 128. Wireless network protocols can comprise Fourth Generation mobile networks or wireless systems (4G or 4G LTE) or Fifth Generation mobile networks or wireless systems (5G or 5G NR), for example. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

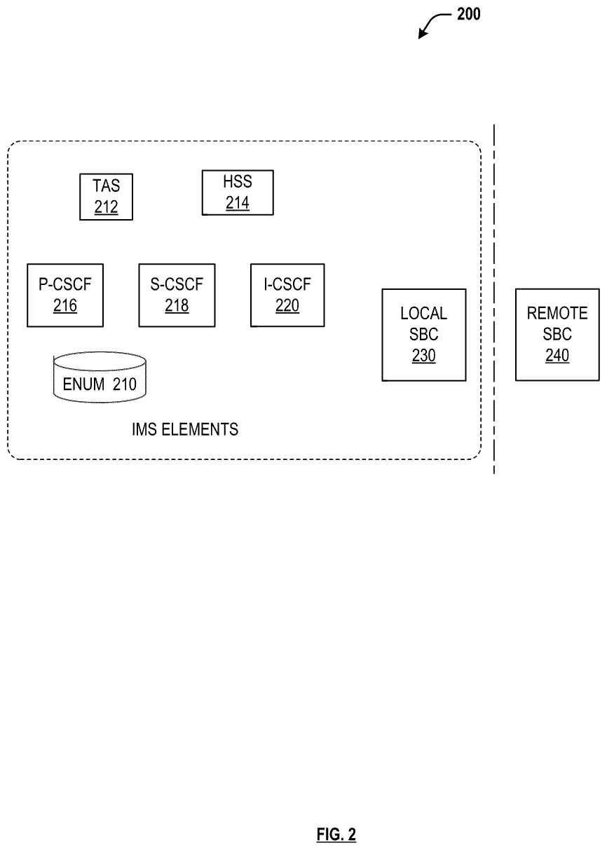

The core network 102 includes the IP Multimedia Subsystem (IMS) 103 which will be explained further in relation to FIG. 2. The core network 102 may be separated into user plane functions and control plane functions. The user plane accesses a data network, such as network 101, and performs operations such as packet routing and forwarding, packet inspection, policy enforcement for the user plane, quality of service (QoS) handling, etc. The control plane handles radio-specific functionality that depends on the idle or connected states of the wireless devices 122, 124, 126, and 128.

Communication links 106 and 108 can use various communication media, such as air, space, metal, optical fiber, or some other signal propagation path—including combinations thereof. Communication links 106 and 108 can be wired or wireless and use various communication protocols such as Internet, Internet protocol (IP), local-area network (LAN), S1, optical networking, hybrid fiber coax (HFC), telephony, T1, or some other communication format—including combinations, improvements, or variations thereof. Wireless communication links may use electromagnetic waves in the radio frequency (RF), microwave, infrared (IR), or other wavelength ranges, and may use a suitable communication protocol, including 4G including 4G NR or 4G Advanced, 5G, 6G, NTN, or combinations thereof.

Communication links 106 and 108 can be direct links or might include various equipment, intermediate components, systems, and networks, such as a cell site router, etc. Communication links 106 and 108 may comprise many different signals sharing the same link.

The RAN 170 may include various access network systems and devices such as access nodes 110, 120, 130. The RAN 170 is disposed between the core network 102 and the end-user wireless devices 122, 124, 126, 128. Components of the RAN 170 may communicate directly with the core network 102 and others may communicate directly with the end user wireless devices 122, 124, 126, 128. The RAN 170 may provide services from the core network 102 to the end-user wireless devices 122, 124, 126, and 128.

The RAN 170 includes multiple access nodes (or base stations) 110, 120, 130, which may include one or more access nodes communicating with the plurality of end-user wireless devices 122, 124, 126, 128. It should be understood that the disclosed technology may also be applied to communication between an end-user wireless device and other network resources, such as relay nodes, controller nodes, antennas, etc. The RAN 170 may further comprise a non-terrestrial network (NTN) serving the multiple UEs by a radio frequency transmission provided by utilizing orbiting satellites that may be in communication with access nodes of a terrestrial network (TN). The satellites may include geosynchronous equatorial orbit (GEO) satellites, Medium Earth Orbit (MEO) satellites, and low Earth orbit (LEO) satellites. The NTN may include NTN nodes that are not stationed on the ground.

Access nodes 110, 120, 130 can be, for example, standard access nodes such as a macro-cell access node, a base transceiver station, a radio base station, an evolved NodeB (or eNodeB) in 4G or 4G LTE, a next generation NodeB (or gNodeB) in 5G New Radio (“5G NR”), or the like. In additional embodiments, access nodes may comprise two co-located cells, or antenna/transceiver combinations that are mounted on the same structure. Alternatively, access nodes 110, 120, 130 may comprise a short range, low power, small-cell access node such as a microcell access node, a picocell access node, a femtocell access node. Access nodes 110, 120, 130 can be configured to deploy one or more different carriers, utilizing one or more RATs. Any other combination of access nodes and carriers deployed therefrom may be evident to those having ordinary skill in the art in light of this disclosure.

The access nodes 110, 120, 130 can comprise a processor and associated circuitry to execute or direct the execution of computer-readable instructions. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless devices 122, 124, 126, and 128 may include any wireless device included in a wireless network. For example, the term “wireless device” may include a relay node, which may communicate with an access node. The qqqqqterm “wireless device” may also include an end-user wireless device, which may communicate with the access node through a relay node. The term “wireless device” may further include an end-user wireless device that communicates with the access node directly without being relayed by a relay node. Wireless devices 122, 124, 126, and 128 may be any device, system, combination of devices, or other such communication platform capable of communicating wirelessly with access node 110, 120, and 130 using one or more frequency bands and wireless carriers deployed therefrom. Each of wireless devices 122, 124, 126, and 128, may be, for example, a mobile phone, a wireless phone, a wireless modem, a personal digital assistant (PDA), a voice over internet protocol (VoIP) phone, a voice over packet (VOP) phone, or a soft phone, a wearable device, an internet of things (IoT) device, as well as other types of devices or systems that can send and receive audio or data. The wireless devices 122, 124, 126 128 may be or include high power wireless devices or standard power wireless devices.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). Communication system 100 may be capable of communicating signals and carrying data, for example, to support voice, push-to-talk, broadcast video, and data communications by end-user wireless devices 122, 124, 126, and 128.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g., between the radio access network 170 and the core network 102.

FIG. 2 illustrates an exemplary operating environment for integrating P-CSCF with ENUM for enhanced network functionality. Components shown in FIG. 2 include IMS Elements: Telephony Application Server (TAS) 212, Home Subscriber Service (HSS) 214, Proxy Call Session Control Function (P-CSCF) 216, Serving Call Session Control Function (S-CSCF) 218, Interrogating Call Session Control Function (I-CSCF) 220, Local Session Border Controller (SBC) 230, and the database for ENUM lookups 210. Also shown is Remote SBC 240. The Remote SBC 240 is part of a different provider's network.

When a wireless device, such as 122, 124, 126, or 128 as shown in FIG. 1, connects with and registers with the provider's network, it receives the address of P-CSCF 216. Then when the wireless device starts the process of making a call, it sends a SIP message containing the request to P-CSCF 216 including the nature of the call (e.g. voice call, video call, RCS, etc.) and the phone number of the destination device. P-CSCF 216 then directly queries the ENUM database 210 for the Uniform Resource Identifier (URI) of the destination device. The ENUM database 210 contains mappings of phone numbers to URIs and may be queried using the Domain Name Service (DNS), SIP Redirection, Lightweight Directory Access Protocol (LDAP), or other protocols. Once P-CSCF 216 has this information, it transmits the request to place a call and the URI of the destination on to S-CSCF 218. Since S-CSCF 218 now has the URI information, it no longer needs to query the ENUM database 210 itself and can proceed with routing the call normally employing the other IMS Elements as necessary.

If the destination device is also on the same provider's network, the call is routed internally within the provider's network. However, if the destination device is on a different provider's network, the call is routed through the Local SBC 230 which works with the Remote SBC 240 to complete the call. If the P-CSCF 216 determines that the destination device is on another provider's network, it may limit the amount of information sent to with the request. For example, the wireless device may have provided to the P-CSCF 216 a whole host of information including the location of the wireless device, and PVNI information, for example. The P-CSCF 216 may typically pass this information as well as other non-standard SIP parameters, including information about the hardware and software being used by the provider, when forwarding the call request. This extra information is not necessary to pass on to the other provider and may be omitted by P-CSCF 216. This omission may save resources necessary to forward this information and it may also prevent the leakage of proprietary information of the provider.

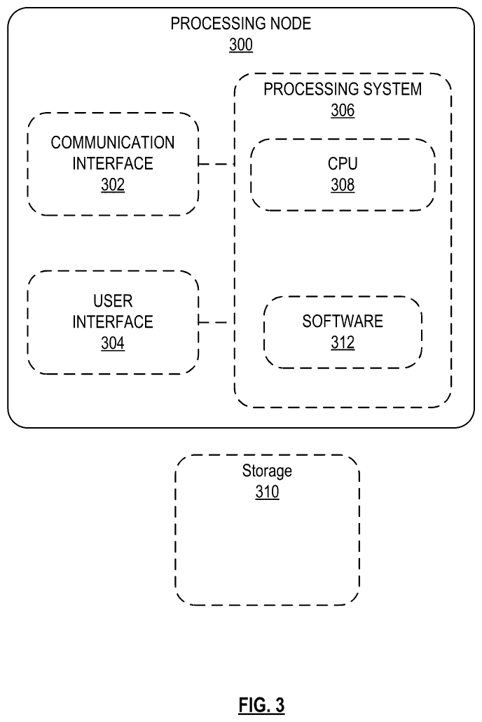

FIG. 3 depicts an exemplary processing node 300, which may be configured to perform the methods and operations disclosed herein for integrating P-CSCF with ENUM for enhanced network functionality. The processing node 300 includes a communication interface 302, user interface 304, and processing system 306 in communication with communication interface 302 and user interface 304. Communication interface 302 may include hardware components, such as network communication ports, devices, routers, wires, antenna, transceivers, etc. User interface 304 may include hardware components, such as touch screens, buttons, displays, speakers, etc.

Processing system 306 includes a processor 308, storage 310, which can comprise a disk drive, flash drive, memory circuitry, or other memory device including, for example, a buffer. Storage 310 can store software 312 which is used in the operation of the processing node 300. Software 312 may include computer programs, firmware, or some other form of machine-readable instructions, including an operating system, utilities, drivers, network interfaces, applications, or some other type of software. Processing system 306 may include a processor 308 and other circuitry to retrieve and execute software 312 from storage 310, which may be internal or external to the processing system 306. Processing node 300 may further include other components such as a power management unit, a control interface unit, etc., which are omitted for clarity. Communication interface 302 permits processing node 300 to communicate with other network elements. User interface 304 permits the configuration and control of the operation of processing node 300. Processing node 300 may be included in various elements of the wireless network including an access node, P-CSCF, S-CSCF, I-CSCF, TAS, HSS, or, SBC, for example.

In an exemplary embodiment, software 212 may include instructions for receiving, at a proxy server (e.g. a P-CSCF server, for example), a request to make a connection from a wireless device to a destination device. The connection may be a voice call, video call, or RCS message, for example. The instructions may further include querying, directly by the proxy server, a database for a URI of the destination device, wherein the database includes mappings of phone numbers to URIs. The database may be queried using the DNS protocol, SIP Redirection, LDAP, or other protocols. The instructions may further include transmitting the request to place a call and the URI of the destination on to other CSCF (e.g. S-CSCF, or I-CSCF, for example) servers as necessary. Since the CSCF server now has the URI information, it no longer needs to query the ENUM database itself. The CSCF server can proceed with routing the call normally, employing other IMS Elements as necessary, without querying the ENUM database.

The instructions may further include determining that the destination device is served by a destination provider different from the originating provider serving the wireless device originating the call. If that is the case, the instructions may further include omitting non-standard SIP parameters from the information forwarded to the CSCF. The non-standard SIP parameters may include the location of the wireless device, PVNI information of the wireless device and any vendor customized parameters, for example.

FIG. 4 illustrates an exemplary method 400 of integrating P-CSCF with ENUM for enhanced network functionality. Method 400 may be performed by any suitable combination of processors discussed herein, for example a processor contained in one of the CSCF servers.

Method 400 begins in step 410 where a request is received at a proxy server (e.g. a P-CSCF server, for example), the request to make a connection from a wireless device to a destination device. The connection may be a voice call, video call, or RCS message, for example. Method 400 continues in step 420 where a database is queried directly by the proxy server for a URI of the destination device. The database includes mappings of phone numbers to URIs, also known as an ENUM database, and may be queried using DNS, SIP Redirection, LDAP, or other protocols.

Method 400 may include the optional step of transmitting the request to make the connection to a CSCF, sending both the request and the URI of the destination device in the transmission. SIP messaging may be used for transmitting this information. Method 400 may include the optional step of determining that the destination device is served by a destination provider different from the provider serving the wireless device originating the connection. If this is found to be true, the proxy server may omit non-standard SIP parameters from the forwarded communication with the CSCF. The non-standard SIP parameters may include the location of the wireless device, PVNI information of the wireless device and any vendor customized parameters, for example.

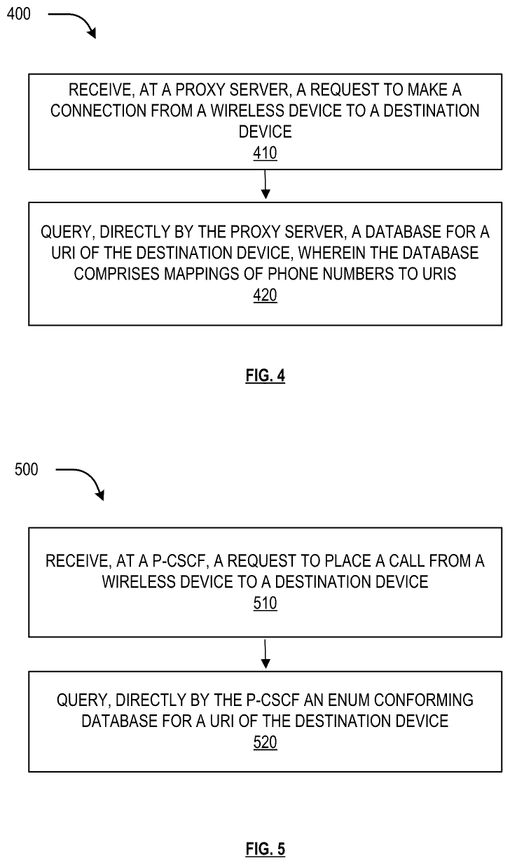

FIG. 5 illustrates an exemplary method 500 of integrating P-CSCF with ENUM for enhanced network functionality. Method 500 may be performed by any suitable combination of processors discussed herein, for example a processor contained in one of the CSCF servers.

Method 500 begins in step 510 where a request is received at a P-CSCF, the request to place a call from a wireless device to a destination device. The call may be a voice call, video call, or RCS message, for example. Method 500 continues in step 520 where an ENUM conforming database is queried, directly by a P-CSCF for a URI of the destination device. The database includes mappings of phone numbers to URIs, also known as an ENUM database, and may be queried using DNS, SIP Redirection, LDAP, or other protocols.

Method 500 may include the optional step of transmitting the request to make the call to a S-CSCF, sending both the request and the URI of the destination device in the transmission. SIP messaging may be used for transmitting this information. Method 500 may include the optional step of determining that the destination device is served by a destination provider different from the provider serving the wireless device originating the connection. If this is found to be true, the proxy server may omit non-standard SIP parameters from the transmitted communication with the S-CSCF. The non-standard SIP parameters may include the location of the wireless device, PVNI information of the wireless device and any vendor customized parameters, for example.

In some embodiments, methods 400 and 500 may include additional steps or operations. Furthermore, the methods may include steps shown in each of the other methods. As one of ordinary skill in the art would understand, the methods of 400 and 500 may be integrated in any useful manner and the steps may be performed in any useful sequence.

The exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, the method comprising:
receiving, at a proxy server, a request to make a connection from a wireless device to a destination device; and
querying, directly by the proxy server, a database for a Uniform Resource Identifier (URI) of the destination device, wherein the database comprises mappings of phone numbers to URIs.

2. The method of claim 1, wherein the proxy server is a Proxy Call Session Control Function (P-CSCF) server.

3. The method of claim 1, wherein the database is queried using one of Domain Name Service (DNS), or Lightweight Directory Access Protocol (LDAP).

4. The method of claim 1, the method further comprising:
transmitting a communication to a Call Session Control Function (CSCF), wherein the communication comprises the request to make the connection and the URI of the destination device.

5. The method of claim 4, wherein the communication is a SIP message.

6. The method of claim 4, the method further comprising:
determining that the destination device is served by a destination provider which is different than an originating provider serving the wireless device; and
omitting non-standard SIP parameters from the communication with the CSCF.

7. The method of claim 6, wherein the non-standard SIP parameters comprise at least one of the following: wireless device location, P-Visited-Network-ID, and vendor customized parameters.

8. The method of claim 1, wherein the connection is one of a voice call, video call, and an RCS message.

9. A system, the system comprising:
a proxy server, including at least one electronic processor configured for executing instructions to perform operations including:
receiving a request to make a connection from a wireless device to a destination device; and
querying a database for a Uniform Resource Identifier (URI) of the destination device, wherein the database comprises mappings of phone numbers to URIs.

10. The system of claim 9, wherein the proxy server is a Proxy Call Session Control Function (P-CSCF) server.

11. The system of claim 9, wherein the database is queried using one of Domain Name Service (DNS), or Lightweight Directory Access Protocol (LDAP).

12. The system of claim 9, the operations further comprising:
transmitting a communication to a Call Session Control Function (CSCF), wherein the communication comprises the request to make the connection and the URI of the destination device.

13. The system of claim 12, wherein the communication is a SIP message.

14. The system of claim 12, the operations further comprising:
determining that the destination device is served by a destination provider which is different than an originating provider serving the wireless device; and
omitting non-standard SIP parameters from the communication with the CSCF.

15. The system of claim 14, wherein the non-standard SIP parameters comprise at least one of the following: wireless device location, P-Visited-Network-ID, and vendor customized parameters.

16. The system of claim 9, wherein the connection is one of a voice call, video call, and an RCS message.

17. A method, the method comprising:
receiving, at a Proxy Call Session Control Function (P-CSCF), a request to place a call from a wireless device to a destination device; and
querying an ENUM database, directly by the P-CSCF using one of DNS, SIP Redirection, and LDAP for a Uniform Resource Identifier (URI) of the destination device.

18. The method of claim 17, the method further comprising:
transmitting the request to place the call and the URI of the destination device to a Serving Call Session Control Function (S-CSCF); and
processing the request to place the call without the S-CSCF querying the ENUM database for the URI of the destination device.

19. The method of claim 18, the method further comprising:
determining that the destination device is served by a destination provider which is different than an originating provider serving the wireless device; and
omitting non-standard SIP parameters from communication with the S-CSCF.

20. The method of claim 19, wherein the non-standard SIP parameters comprise at least one of the following: wireless device location, P-Visited-Network-ID, and vendor customized parameters.
